(19) United States
(12) Patent Application Publication
(10) Pub. No.: US 2003/0145040 A1
(43) Pub. Date: Jul. 31, 2003

(54) DATABASE ACCESS SYSTEM AND RECORDING MEDIUM WHICH RECORDS PROGRAM FOR CONTROLLING THE SYSTEM

(76) Inventors: TOSHIO TOHARA, TOKYO (JP); MASAAKI FUKUMURA, IRUMA-SHI (JP); AKIHITO IWADATE, TOKYO (JP)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 09/387,426

(22) Filed: Aug. 31, 1999

(30) Foreign Application Priority Data
Sep. 4, 1998 (JP) 251428/1998

(51) Int. Cl. G06F 15/16; G06F 17/30; G06F 7/00

(52) U.S. Cl. 709/203; 707/10; 707/104.1

(57) ABSTRACT

A data access system can access a plurality of database servers distrivitively arranged on a network. A user defines and records, with respect to each of the tables stored in a database, links from the table to another table stored in another database in a data link information file and the manner of displaying data in a specification file with her/his WWW client through a WWW server and the database server. The WWW server, when the user accesses a table stored in the database through the database server from her/his WWW client, refers the data link information file and detects the link to another table in the another database, and accesses the another table. It displays accessed data items of the another table in the manner defined in the corresponding one of the specification files.

### BACKGROUND OF THE INVENTION

1. Field of the Invention

The present invention relates to a technique for accessing, in an easy manner, data which are stored in a plurality of database servers distributively arranged on a network.

2. Description of the Related Art

According to the development of the network computing technology, a data-access system, in which a database is stored in a server computer and the database is accessed from client computers via a network, has been developed so as to be generalized. Particularly, by using World Wide Web (WWW) interface as an User Interface to access the database from the client computers, users can easily access the database with browser applications on their client computers. Further, users can easily design original business database systems, etc with the WWW interface.

In a data-access system, which operates through a network and which can be organized by a user, WWW-based forms for accessing the database server are stored in a WWW server into which software for processing requests from WWW browser is installed.

A precondition for such a data-access system is that a database to be accessed by the WWW server exists on a single server computer (database server).

However, in many cases, a database system, for example, a sales management database system, can be efficiently managed when a plurality of databases are arranged at a plurality of offices and stores distributively.

In this case, it is necessary to design the database access system capable of accessing the database servers distributively arranged via a server located, for example, at the main office.

As a data access system which can access distributively arranged database servers in a network environment which has an exclusive client-server system and exclusive communication lines, there is a system which uses an originally designed and developed database access program having original interface.

However, it has been a difficult task for the general users to originally design and develop the data-access system on the WWW basis, which can access a plurality of distributively-arranged database servers.

### SUMMARY OF THE INVENTION

Accordingly, an object of the present invention is to provide a data-access system having distributively arranged databases on a plurality of sites on a network, and being capable of providing a connection between the databases.

According to the present invention, there is provided a database access system which accesses tables contained in a plurality of databases distributively arranged on a network, the system comprising:

data link information defining means which defines, in a data link information file, a link from a table contained in one of the plurality of databases to another table in another database in the plurality of databases, with respect to each table contained in the plurality of databases which are distributively arranged on the network; and

database retrieval means which retrieves, when accessing a table contained in one of the plurality of databases, a link from the table to another table contained in another database in the plurality of databases, by referring to the data link information file, and which accesses the another table linked from the accessed table contained in the another database specified by the data link information file.

### BRIEF DESCRIPTION OF THE DRAWINGS

The object and other objects and advantages of the present invention will become more apparent upon reading of the following detailed description and the accompanying drawings in which:

FIG. 1 is a diagram for explaining the principle of the present invention;

FIGS. 2A to 2E are diagrams showing screen transitions according to one embodiment of the present invention; FIG. 3 is a diagram showing a systematic structure of a database-access system according to one embodiment of the present invention;

FIG. 4 is a diagram showing a functional structure according to one embodiment of the present invention;

FIG. 5 is a diagram showing a data structure of an article/office sales management table, in which sales data is classified according to articles and offices and which is stored in a database located on a head office site;

FIG. 6 is a diagram showing a data structure of an article/type/product sales management table, in which sales data is classified according to articles, product types and products and which is stored in the database located on local office sites;

FIG. 7 is a diagram showing a data structure of a sales slip table, in which sales data is classified according to slip numbers, dates, responsible persons and product names and which is stored in the database located on local office site A;

FIG. 8 is a diagram showing a data structure of a sales management table, on which sales data is classified according to articles, product types and products and which is stored in a database located on a local office site B;

FIG. 9 is a diagram showing a data structure of a sales slip table in which sales data is classified according to slip numbers, dates, responsible persons and product names and which is stored in the database located on local office site B;

FIG. 10 is a diagram showing a data structure of a specification file including the sales management table in which sales data is classified according to articles and offices;

FIG. 11 is a diagram showing a data structure of a specification file including the sales management table in which sales data is classified according to articles, product types and products;

FIG. 12 is a diagram showing a data structure of a specification file including the sales slip table;

FIG. 13 is a diagram showing a data structure of a data link information file including the sales management table in which sales data is classified according to articles and offices;

FIG. 14 is a diagram showing a data structure of a data link information file including the sales management table, in which sales data classified according to articles, product types and to products are managed;

FIG. 15 is a diagram showing a data structure of a data link information file including the sales slip table;

FIG. 16 is a flowchart for explaining a process operated by a user;

FIG. 17 is a flowchart for explaining a process for preparing a specification file;

FIGS. 18A to 18C are diagrams each illustrating an operational screen in a process for preparing a specification file;

FIG. 19 is a flowchart for explaining a process of preparing a data link information file;

FIGS. 20A and 20B are exemplary diagrams each illustrating an operational screen displayed in a process for preparing a data link information file;

FIG. 21 is a flowchart for explaining a search process;

FIG. 22 is a flowchart for explaining a process for displaying a to-be-linked information form;

FIG. 23 is a diagram showing an operational sequence of a retrieval process;

FIG. 24 is a diagram showing a data structure of a log-on management information file; and

FIG. 25 is a diagram exemplifying a display screen according to another embodiment of the present invention.

### DETAILED DESCRIPTION OF THE PREFERRED EMBODIMENT

An embodiment of the present invention will now be described with reference to the accompanying drawings.

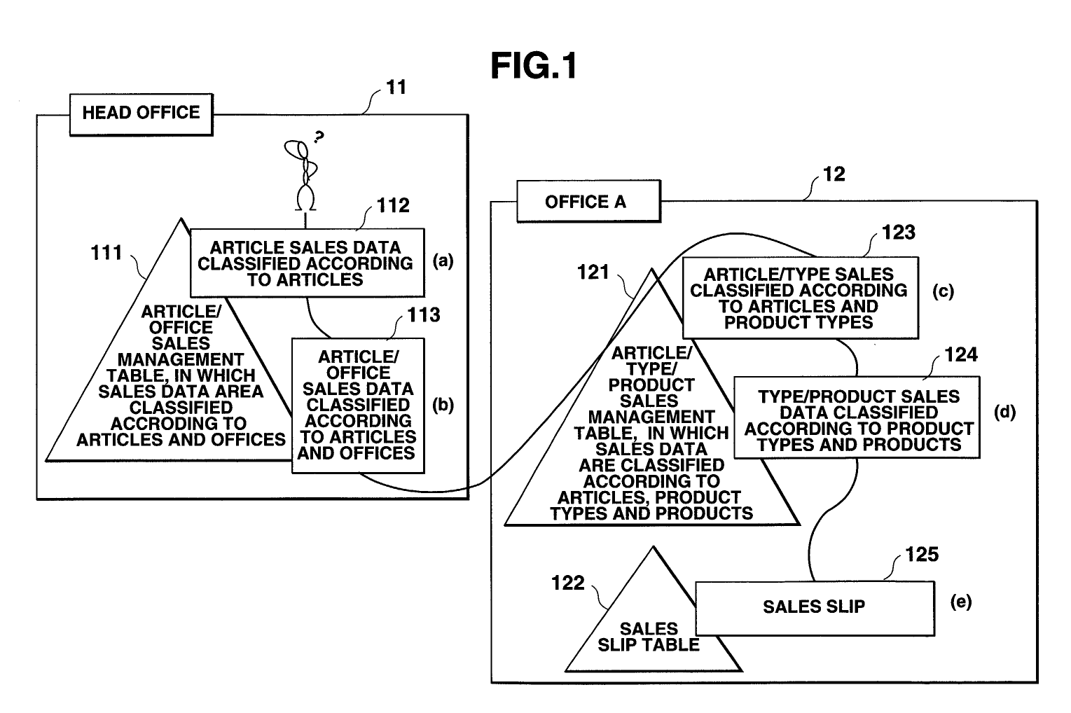

In the embodiment of the present invention, as illustrated in FIG. 1, database servers 11, 12 are located on the sites of a head office and local offices such as a local office A. Data is stored in the database servers distributedly. For example, the database server 11 of the head office stores an article/office sales management table, in which sales data is classified (sorted) according to articles and offices so as to manage sales of each article at each office. The database server 12 of the local office stores an article/type/product sales management table relating to own offices in which sales data is classified according to articles, product types (categories to which products belong) and a sales slip table relating to own office.

A user at the head office, for example, connects her/his WWW (World Wide Web) client to a WWW (World Wide Web) server both located on the head office, then the WWW server accesses the article/office sales management table 111 contained in the database 11 located on the head office.

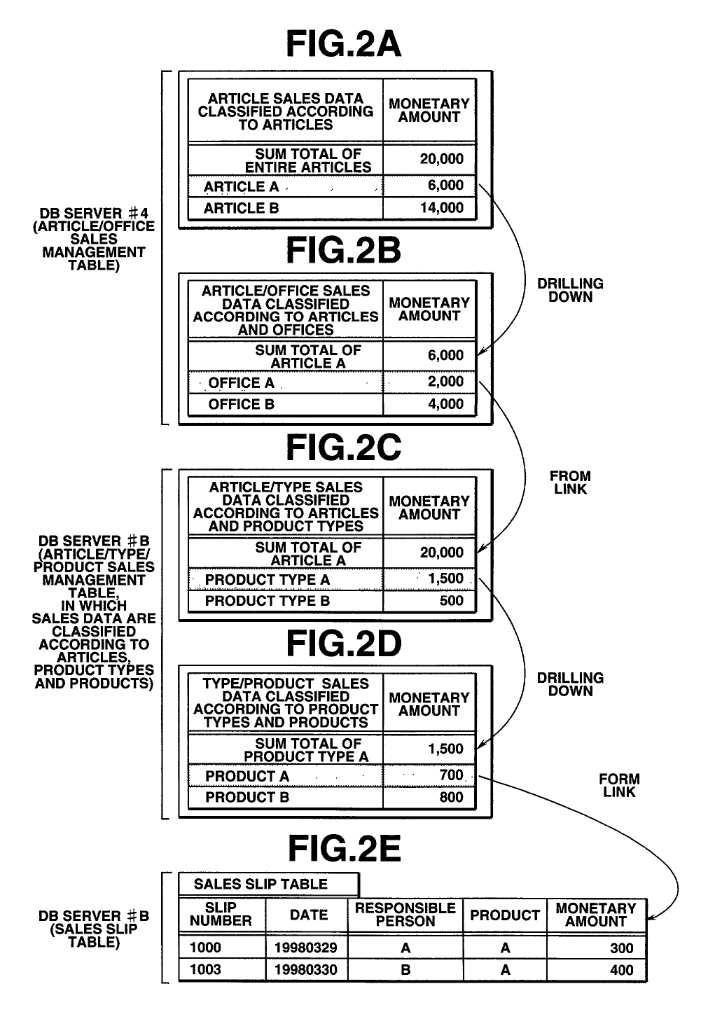

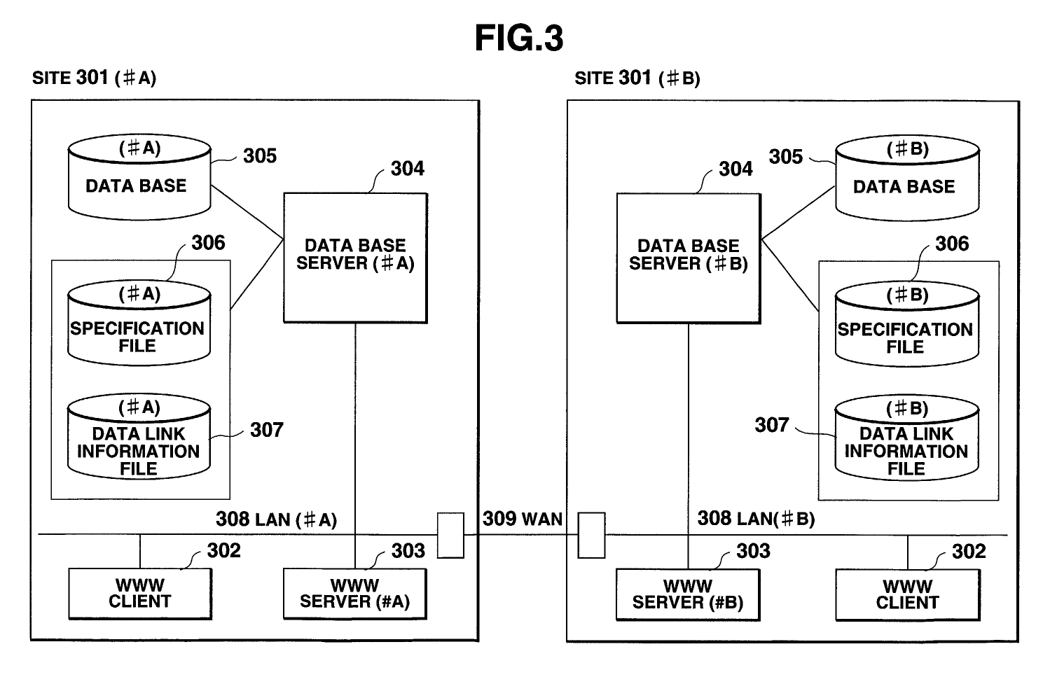

As a result, the user can display the article sales data 112 classified based on articles, as shown in FIGS. 1 and 2A.

The user then drills down one displayed data item with a mouse click, so that article/office sales data 113 of selected article classified according to offices is displayed as shown in FIGS. 1 and 2B.

In this case, the WWW server on the site of the head office accesses the article/office sales management table 111, in which sales data is classified article by article, contained in the database server 11 located on the same site. Further, the WWW server allows the WWW browser of the WWW client to display the article sales data 112 classified according to articles and the article/office sales data 113 classified according to articles and offices.

The method for displaying each data item included in the sales data is determined by referring to a metafile called as “specification file” which is set in a manner corresponding to the article/office sales management table stored in the database 11 on the head office site.

The user selects, by means of a mouse click, one office A shown in the displayed article/office sales data 113 so as to display article/type sales data 123 classified according to articles and product types as shown in FIGS. 1 and 2C. In this case, the WWW server on the head office site refers a metafile called “data link information file”, which is set in a manner corresponding to the article/office sales management table 111, contained in the database 11 on the head office site. By referring to the data link information file, the WWW server determines that there is a link (form link) to an article/type/product sales management table 121, in which sales data of office A is classified according to articles, product types and products, stored in the database server 12 on the site of the office A. Then the WWW server on the head office site accesses the sales article/type/product management table 121 stored in the database server 12 on the office A, and allows the WWW browser of the WWW client located on the head office site to display the article/type sales data 123 of the local office A classified according to articles and product types. The way for displaying data items included in the article/type sales data 123 is determined by referring to the specification file which is set in a manner corresponding to the article/type/product sales management table 121 contained in the database 12 on the site of the local office A.

Sequentially, the user drills down a product type A shown in the displayed article/type sales data 124, with a mouse click, so as to display the type/product sales data as shown in FIGS. 1 and 2D.

Further, the user selects, by a mouse click, a particular product shown in the displayed article/type sales data 124, so as to display a sales slip table 125 of the user-selected product A, as shown in FIGS. 1 and 2E. In such a case, the WWW server on the head office site refers to a data link information file set in a manner corresponding to the article/type/product sales management table 121 contained in the database 12 on the local office A site. The WWW server determines that a form link to the sales slip 125 of the product A, which is stored in the database server 12 on the local office A site, exist. The WWW server on the head office site accesses the sales slip 125 along the form link so as to allow the WWW browser of the WWW client on the head office site to display the sales slip 125. The method for displaying data items in the sales data is determined by referring to a specification file which is set in a manner corresponding to a sales slip table 122 contained in the database 12 on the local office A site.

Detailed structures and operations of an embodiment of the present invention, for realizing the above-described operation and processes will now be described.

FIG. 3 is a diagram showing a systematic structure of one embodiment of the present invention.

Sites 301 (#A) and 301 (#B) are connected with each other through a WAN (Wide Area Network). FIG. 3 illustrates simply two sites 301 connected with each other, by way of example, and a larger number of sites 301 connected therewith can be included.

One site 301 has a structure in which a database server 304, a WWW client 302 and a WWW server 303 are connected with one another via a LAN (Local Area Network) 308.

The database server 304 stores and manages a database 305 associated with the own site 301, a specification file 306 and a data link information file 307 both being associated with the database 305.

The WWW client 302 runs a WWW browser application which the user operates.

The WWW server 303 processes a request transmitted from the WWW client 302, and accesses to the database server 304 located either on the same site or on another site.

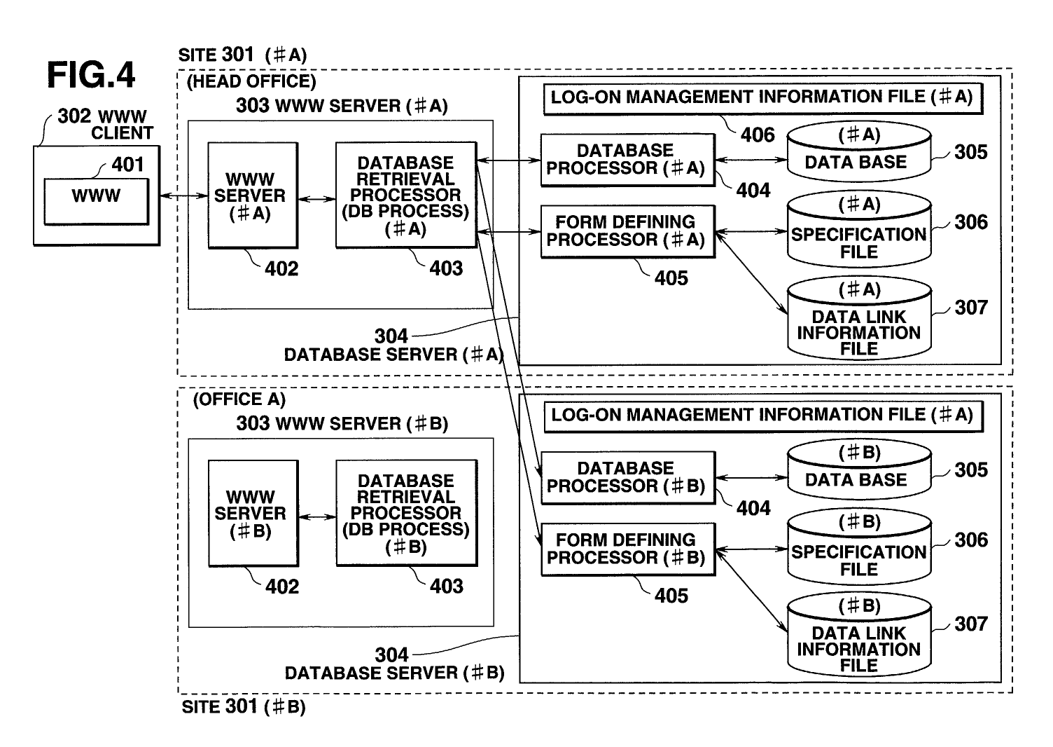

FIG. 4 is a diagram showing a functional structure of this embodiment.

The database server 304 includes not only the database 305, the specification file 306 and the data link information file 307, but also a database processor 404 for performing log-in sequences and access to the database 305, a log-on management information file 406 for retaining information regarding the log-in sequences performed by the database processor 404, and a form-defining processor 405 for managing the specification file 306, the data link information file 307 and form definition.

The WWW server 303 includes a WWW server unit 42 and a database retrieval processor 403. The WWW server unit 402 processes a request transmitted from WWW browser 401 in the WWW client 302. The database retrieval processor 403 accesses the form-defining processor 405 and the database processor 404 contained in the database server 304 located on its own site 301 or on anther site 301, in accordance with an instruction sent from the WWW server unit 402.

The database processor 404 included in the database server 304 and the database retrieval processor 403 included in the WWW server 303 are realized by executing programs stationed in main memories of the server 304 and 303 respectively as process, every time access from the user (the WWW browser 401 shown in FIG. 4) of the WWW client 302 is approved.

For example, the WWW server 303 on the site 301 (#B) serving as a site of the office A accesses the database server 304 on the same site, so that the system can be organized as for managing only the database 305 specialized for its office, i.e., the local office A. On the other hand, the WWW server 303 on the site 301 (#A) serving as a site of the head office accesses not only the database server 304 located on the same site, but also the database server 304 arranged on the site 301 (#B) which is linked with the database 305 on the own site. Thus, the system is organized as that the databases 305 distributively arranged at the head office and branch offices can be seamlessly accessed.

The user can arbitrarily define a table stored in the database 305 which is contained in the database server 304, from the WWW browser 401 (shown in FIG. 4) of the WWW client 302. Such a process for defining the table can easily be realized through the utilization of a known database organization tool.

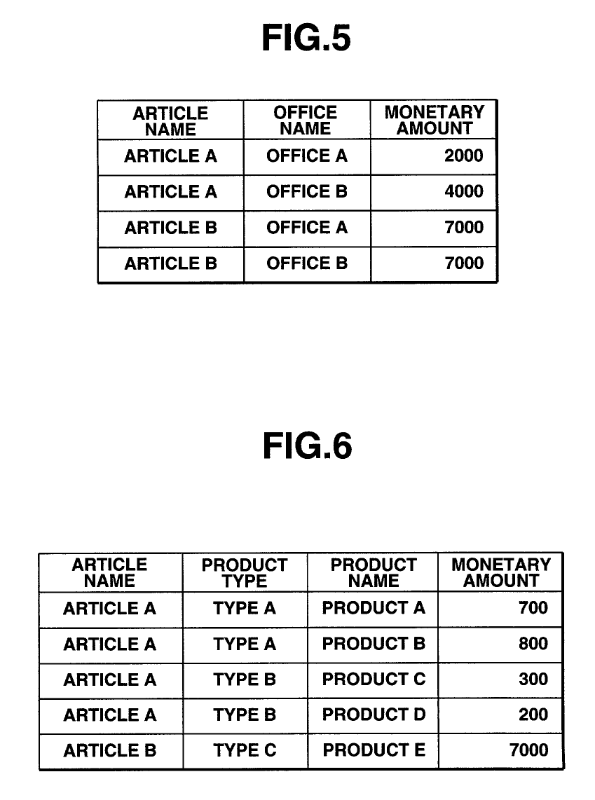

FIG. 5 is a diagram showing a data structure of an article/office sales management table, in which sales data is classified according to articles and offices, which is stored in the database 305 (#A) included in the database server 304 (#A) located on the site 301 (#A). In the article/office sales management table, for example, three categories of data items, such as article name, office name and monetary amount (sales amount) are defined. The aggregated data regarding each of the offices, which should be collected under the responsibility of the head office, are registered in this table.

FIG. 6 is a diagram showing a data structure of an article/type/product sales management table, in which sales data are classified according to articles, product types and products, and which is retained by the database 305 (#B) included in the database server 304 (#B) located on the site 301 (#B). In the article/type/product sales management table, for example, four categories of data items, such as article name, product type, product and monetary data items are defined.

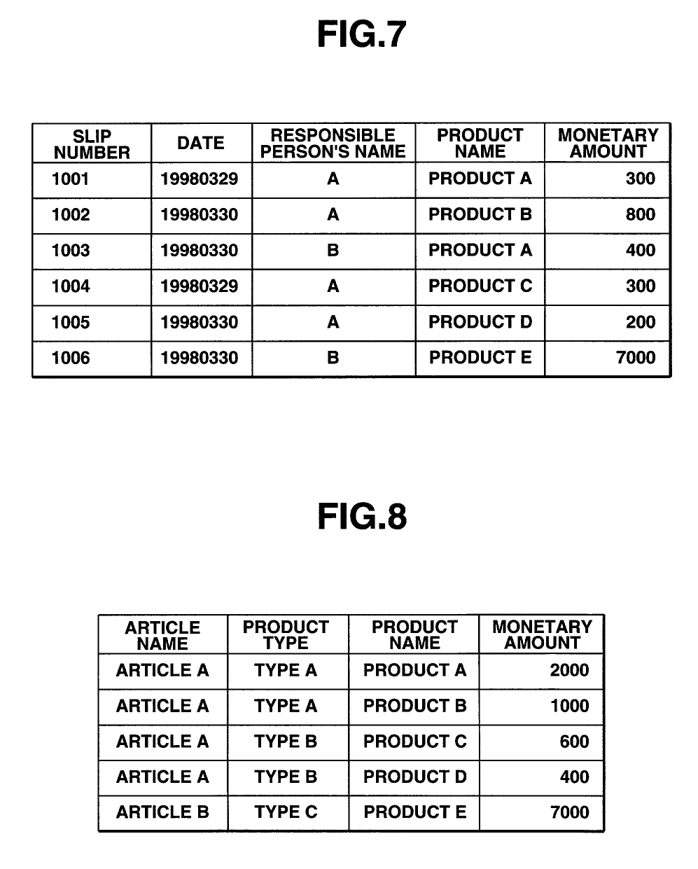

FIG. 7 is a diagram showing a data structure of a sales slip table stored in the database 305 (#B) included in the database server 304 (#B) which is located on the site 301. In the sales slip table, for example, five categories of data items, such as slip number, date items, responsible person (person in charge), “product name” items and monetary amount, are defined. Data regarding the office A corresponding to the site 301 (#B) are registered in the article/type/product sales management tables and sales slip table shown in FIGS. 6 and 7, respectively.

For example, a database 305 (#C) contained in a database server 304 (#C) on a site 301 (#C) serving as a site of an office B retains the same article/type/product sales management table as that shown in FIG. 6 and the same sales slip table as that shown in FIG. 7. Data regarding the office B corresponding to the site 301 (#C) is registered in these tables.

FIG. 10 is a diagram showing a data structure of a specification file of the article/office sales management table. The user defines, from the WWW browser 401 (shown in FIG. 4) of the WWW client 302, the specification file which is retained in the database server 304 (#A) of the site 301 (#A).

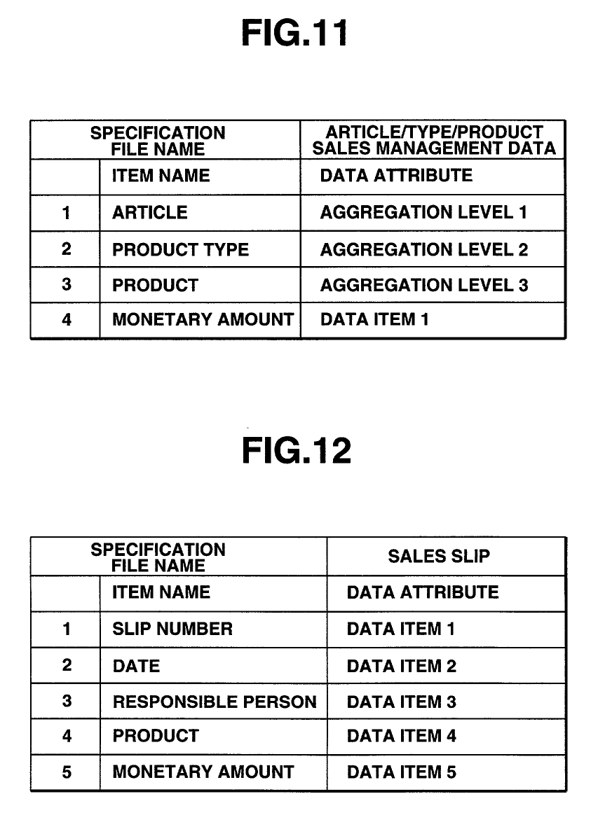

FIG. 11 is a diagram showing a data structure of the specification file 306 of the article/type/product sales management table. The specification file is retained in the database server 304 located on each of the sites 301 (#B) and (#C). FIG. 12 is a diagram showing a data structure of the specification file 306 of the sales slip table which is retained in the database server 304 located on each of the sites (#B) and (#C).

The specification file 306 is a metafile for specifying a method or way for displaying data items managed in a corresponding table, in a case where the WWW browser 401 (FIG. 4) contained in the WWW client 302 displays the table retained in the database 305 through the WWW server 303.

Corresponding table's names retained in the database 305 are specified or set in a “specification file name” items of the specification file 306. In the example shown in FIG. 10, the “article/office sales management” is specified in that item. In the example shown in FIG. 11, the “article/type/product sales management” is set in that item. In the example shown in FIG. 12, the “sales slip” is set.

Names of data items to be displayed when a corresponding table is displayed are specified in “article name” items in the specification file 306. In the example shown in FIG. 10, “article”, “office” and “monetary amount” are specified. In the example shown in FIG. 11, “article”, “product type”, “product” and “monetary amount” are specified. In the example shown in FIG. 12, “slip number”, “date”, “responsible person”, “product” and “monetary amount” are specified.

A method for displaying each data item is specified in a “data attribute” item of the specification file 306.

In the example shown in FIG. 10, an “aggregation level 1” is specified as a data attribute of the “article”. The aggregation level 1 is defined in the article/office sales management table. The “aggregation level 1” is defined to aggregate and display monetary amount data registered in the monetary amount items for each article when article names registered in the article/office sales management table is displayed. A display method, defined as an “aggregation level 2”, is specified as a data attribute of the “office name”. The “aggregation level 2” is defined to aggregate and display monetary amount data registered in the “monetary data” items for each office name in association with the selected article name included in the table. A “Data item 1” is specified as a data attribute of the “monetary amount” item. The “data item 1” is a name of a data item which is contained in the database 305 and which corresponds to the monetary amount item (shown in FIG. 5) registered in the article/office sales management table registered in the database 305.

In the example shown in FIG. 11, an “aggregation level 1” is specified as a data attribute of the “article name”. The “aggregation level 1” is defined to aggregate and display monetary amount data which are registered in the “monetary amount” items for each article registered in the article/type/product table when the list of the articles registered in the article/type/product. Further, an “aggregation level 2” is specified as a data attribute of the “product type” data item. The “aggregation level 2” is defined to aggregate and display monetary amount data registered in the “monetary amount” items, when a data table regarding product types is displayed in association with a selected article name included in the sales management table, in which sales data classified according to article names, product types and to products are managed. When the data table is displayed, it is defined to aggregate and display monetary amount data registered in the “monetary amount” items, at each product type name in association with a selected article name in the table. A display method, which is defined as an “aggregation level 3”, as a data attribute of the “product name” data item is specified. In this “aggregated level 3”, a data table regarding product names is displayed in association with a selected article name and a selected product type name contained in the sales management table, in which sales data classified according to articles, product types and to product are managed. In this case, it is defined to aggregate and display monetary amount data registered in the “monetary amount” item, at each product name in association with a selected article name and product type name included in the management table. Further, a “data item 1” is specified to be displayed as a data attribute of the “monetary amount” data item. The “data item 1” is a data item name which is registered in the database 305 and which corresponds to the monetary amount data item (FIGS. 6 and 8) included in the article/type/product sales management table in the database 305.

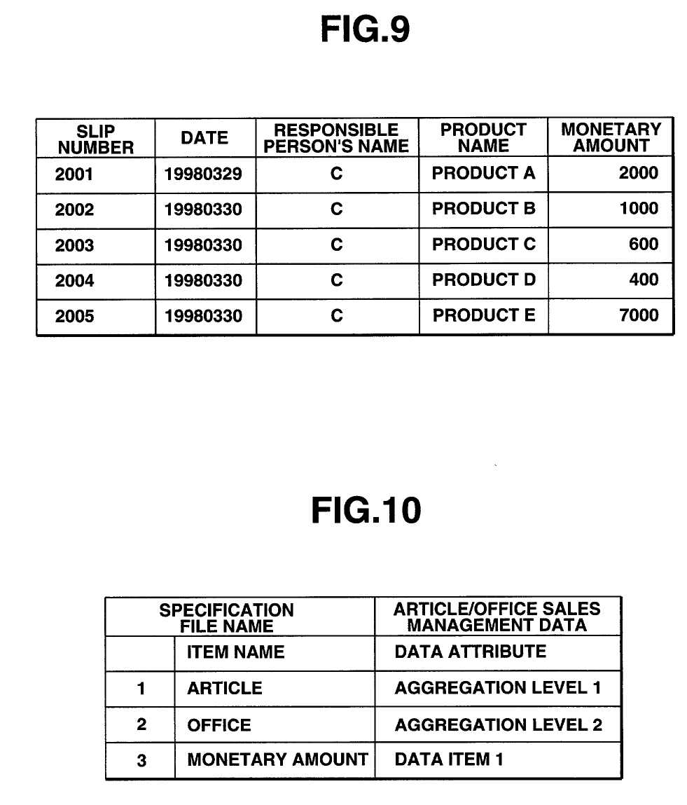

In the example shown in FIG. 12, display of “data item 1” to “data item 5” are specified as data attributes of “slip number”, “date”, “responsible person”, “product name” and “monetary amount”, respectively. These “data item 1” to “data item 5” represents data item which is registered in the database 305 and which corresponds to the slip number, the date, the responsible person, the product name and the monetary amount (shown in FIGS. 7 and 9).

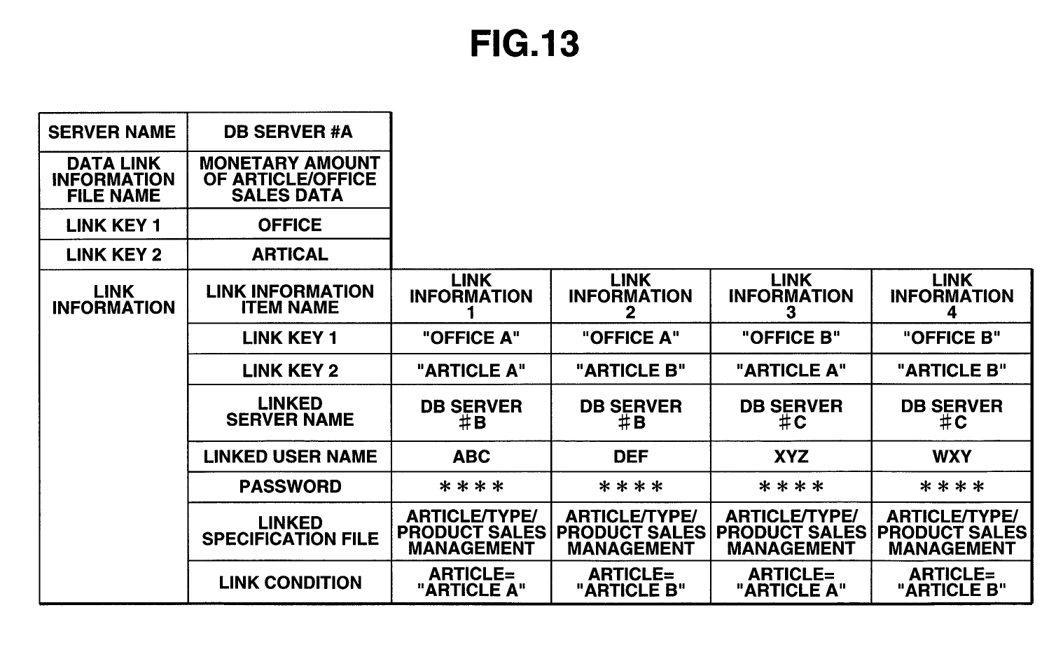

FIG. 13 is a diagram showing a data structure of the data link information file 307 of the article/office sales management table, in which sales data is classified according to articles and offices. The data link information file 307 is defined by the user via the WWW browser 401 (FIG. 4) of the WWW client 302 and is retained in the database server 304 (#A) located on the site (#A).

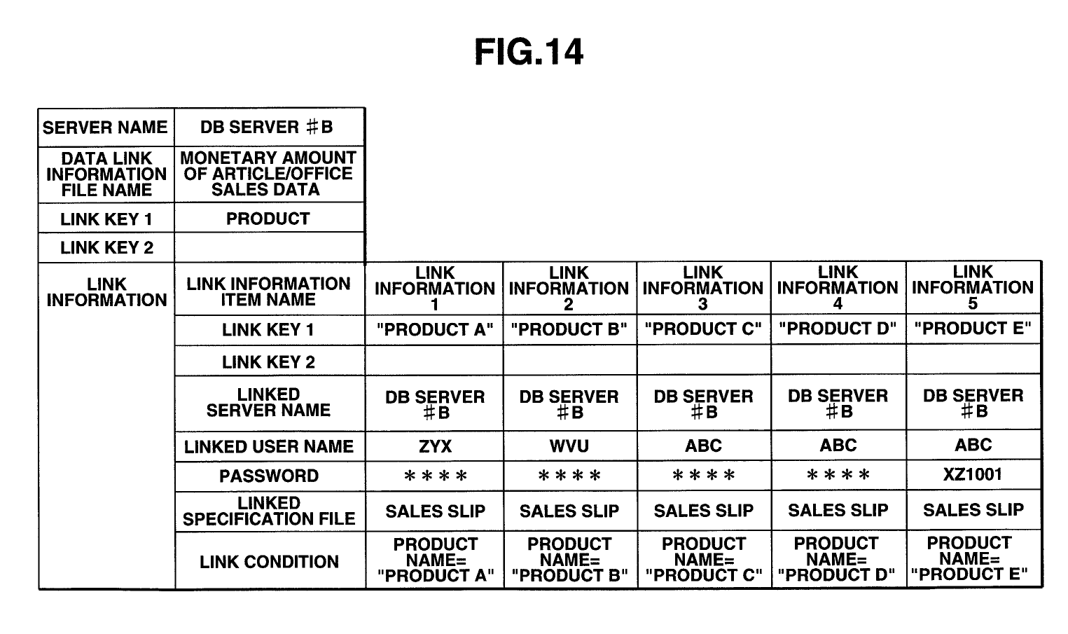

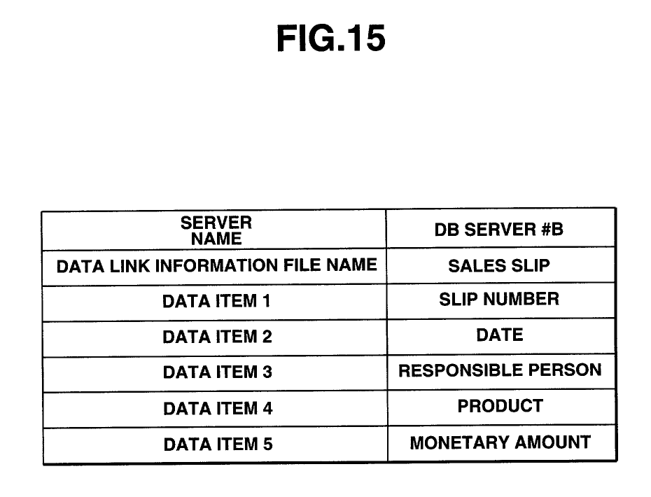

FIG. 14 is a diagram showing a data structure of the data link information file 307 of the article/type/product sales management table, in which sales data is classified according to articles, product types and products. The sales management table is retained either in the database server 304 (#B) or (#C) located on a corresponding site 301 (#B) or (#C). FIG. 15 is a diagram showing a data structure of the data link information file 307 of the sales slip table which is retained in the database server 304 (#B) or (#C) located on a corresponding site 301 (#B) or (#C).

The data link information file 307 is a metafile for referring to the table retained in the database 305 located on the “another” site 301, when a certain value or item is selected in the corresponding table contained in the database 305.

In the data link information file 307, a name of the database server 304 corresponding to the data link information file is specified in the server name item. FIG. 13 illustrates the data structure in which the server name “DB server A” corresponding to the database server 304 (#A) is specified. Each of FIGS. 14 and 15 illustrates the data structure in which the server name “DB server B” corresponding to server 304 (#B) is specified.

The name of the data link information file 307 itself is specified in the “data link information file name” item thereof. Names of the first and second items to be determined when a link is established, are respectively specified in a “link key 1” item and a “link key 2” item of the data link information file 307. The user can arbitrarily specify the number of the link keys, in a range from one up until five. In FIG. 13, the “office name” is specified as the “link key 1” item, whereas the “article name” item is specified as the “link key 2” item. In FIG. 14, the “product name” is specified as the “link key 1”.

The group of the “data link information” items, contained in the data link information file 307, includes a “link information item name” item, corresponding item values of “the link keys 1 to 2 (up to 5, at most)”, a “linked server name” item, a “linked user name” item, a “password” item, a “linked specification file name” item and a “link condition” item. For example, in FIG. 13, at the link information item “link information 1”, an “office A” as in the “link key 1” item, and an “article A” as in the “link key 2” item are set. Similarly, a “DB server B” as the “linked server name”, “ABC” as the “linked user name”, “****” (hidden on the display) as “password”, an article/type/product sales management table as the “linked specification file” and article=“article A” as the “link condition” item are set. In this case, the manner or method of displaying data is defined as follows. First, the user can log-in the database server 304 (#B) corresponding to the linked server name “DB server B” with the linked user name “ABC” and the required password “****” (hidden on the display) when an “office A” is designated as the “link key 1” and an “article A” as the link key 2. Then, It refers to the specification file 306 having a name, article/type/product sales management, defined by the “linked specification file name” item and the corresponding article/type/product sales management table stored in the database 305(#B) and extracts the record having an article name, “article S”, so as to display the extracted data.

In an example of “link information 1” of FIG. 14, the manner or way of displaying data is defined in the following link condition. First it can log-in the database server 304 (#B) corresponding to the linked server name “DB server B”, with the linked user name “ZYX”/password “****” (hidden on the display) when a “product A” is specified as “link information 1”. Then, It refers to the specification file 306 having a name of sales slip in the database 305 (#B) and corresponding sales slip table in the database 305 (#B), then, it extracts the record whose “product name” item is “article A” and displays the extracted data.

In the example of FIG. 15, there is no links from the sales slip table, thus only the name of each data item is specified.

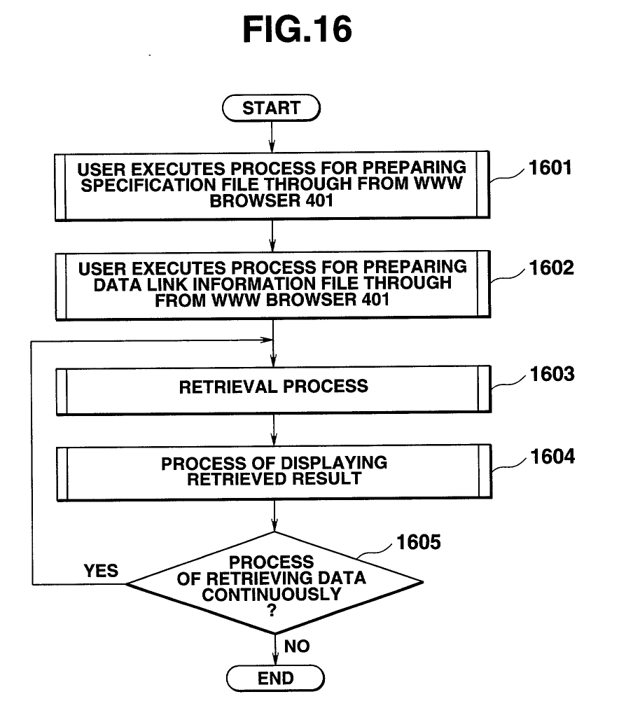

The operation of the users will be described with reference to FIG. 16. FIG. 16 is a flowchart for explaining the entire operations performed by the user.

First, the user executes a process for preparing the specification file with the WWW browser 401 (shown in FIG. 4) of the WWW client 302 (Step 1601). As a result of this, the specification files 306 having the data structure shown in FIGS. 10 to 12 are formed.

The user then executes a process for preparing the data link information file with the WWW browser 401 (Step 1602). As a result of this, the data link information files 307 having the data structure shown in FIGS. 13 to 15 are formed.

Sequentially, the user executes a retrieval process (Step 1603), and a process for displaying a retrieved result (1604). If it is determined that further retrieval is necessary (Step 1605), the retrieval process (Step 1603) and the process for displaying the retrieved result (Step 1604) are continuously repeated.

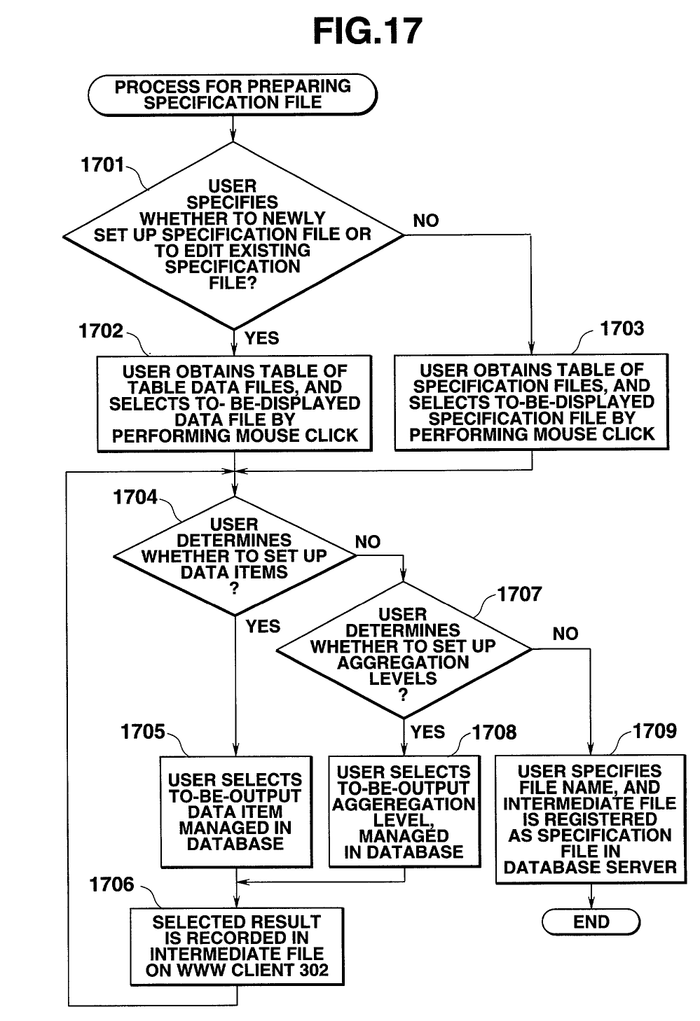

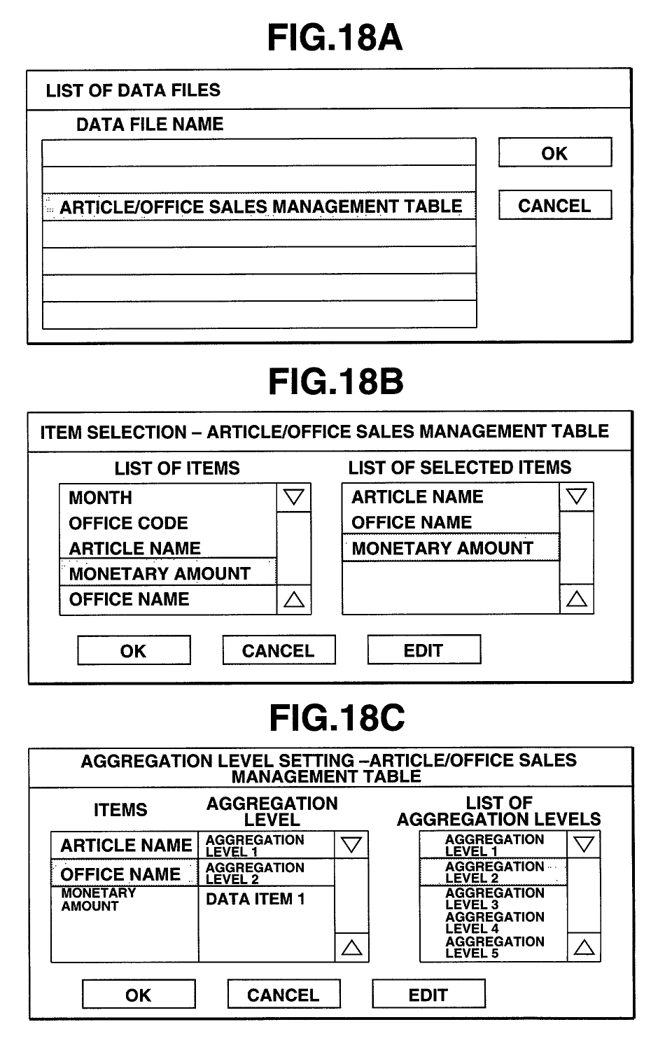

FIG. 17 is a flowchart for explaining, in detailed, a process for preparing the specification file, shown in FIG. 16. This process is realized as a process in which the WWW browser 401 in the WWW client 302 executes a JAVA applet program which has been downloaded from the WWW server 303. It should be noted that the JAVA applet is a programming technique which has been developed by Sun Microsystems, Inc. in the U.S. FIGS. 18A to 18C is a diagram exemplifying screens of the WWW browser 401 in the process for preparing a specification file.

First, the user specifies, from the WWW browser 401, whether to newly set up the specification file 306 or to edit the existing specification file 306 (Step 1701).

In the case where the user specifies to newly set up the specification file 306 (“YES” in Step 1701), a list of the table data files stored in the database server 304 located on the site 301 from which the user accesses, is obtained (Step 1702). The obtained list is displayed by the WWW browser 401 as shown in FIG. 18A. The user selects one of the to-be-displayed table data files by a mouse click, and ensures the selected table data file by clicking an “OK” button arranged on the screen (Step 1702).

On the contrary, in the case where the user determines to edit the existing specification file 306, a list of specification files 306, which is stored in the database server 304 on the site 301 from which the user currently accesses, is obtained (Step 1703). The obtained list is displayed by the WWW browser 401. The user selects one of the to-be-displayed specification files 306 by a mouse click, and ensures the selected file by clicking an “OK” button (Step 1703).

The user specifies setting-up of items in the table (“YES” in Step 1704). In response to this selection, the WWW browser 401 displays the screen shown in FIG. 18B. This screen includes a left-hand side window on which the list of the item to be selected is displayed and a right-hand side window on which a list of selected items is displayed. The user selects, by mouse click, one or more arbitrary items, which are to be output on the table defined by the selected table data file, from the list displayed in the left-hand side window. Selected items are displayed on the right-hand side window (Step 1705).

If the user depresses the “OK” button shown in FIG. 18B, the selected result is recorded in an intermediate file on the WWW client 302 (Step 1706).

When the items are completely set up through the above-described steps 1704 to 1706, the user specifies to set up aggregation levels (“NO” in Step 1704 and “YES” in Step 1707).

Then the browser 401 displays a screen shown in FIG. 18C. This screen includes left-hand side window and right-hand side window. The left-hand side window includes left-hand area showing the list of the selected items, and right-hand area into which aggregation levels selected by the user are inserted. The right-hand side window includes list of aggregation levels which the user can select.

The user selects an aggregation level from the list displayed on the right-hand side window, for each item which is contained in the list displayed on the left-hand side area of the left-hand side window, by performing a mouse click on the browser screen. Clicked aggregation level is displayed left-hand window so as to correspond to the items so that the aggregation level of each selected item is set up (Step 1708). A preferable data item is previously assigned to each item as a default.

If the user depresses an “OK” button which is shown in FIG. 18C, the selection result is stored in an intermediate file on the WWW client 302 (Step 1706).

When the user completes setting of the items and the aggregation levels through the above-described steps 1704 to 1708, the intermediate file in the WWW client 302 is transmitted to the database server 304 located on the site 301, where the user currently accesses data through the WWW client 302. Following the user specifies the file name, the intermediate file is registered as a specification file 306 in the database server 304 (Step 1709).

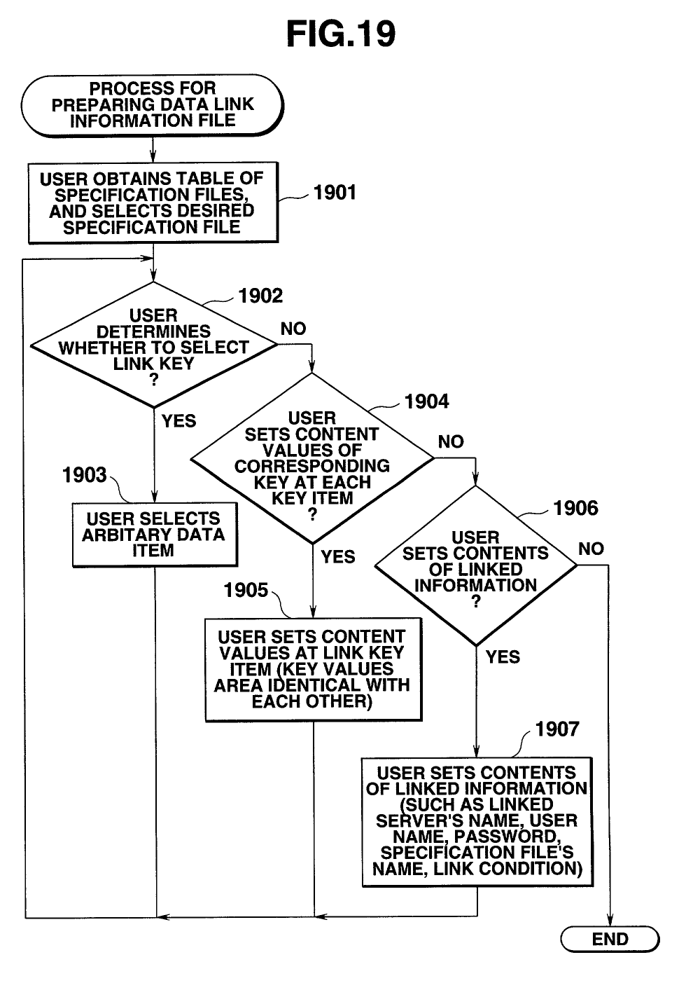

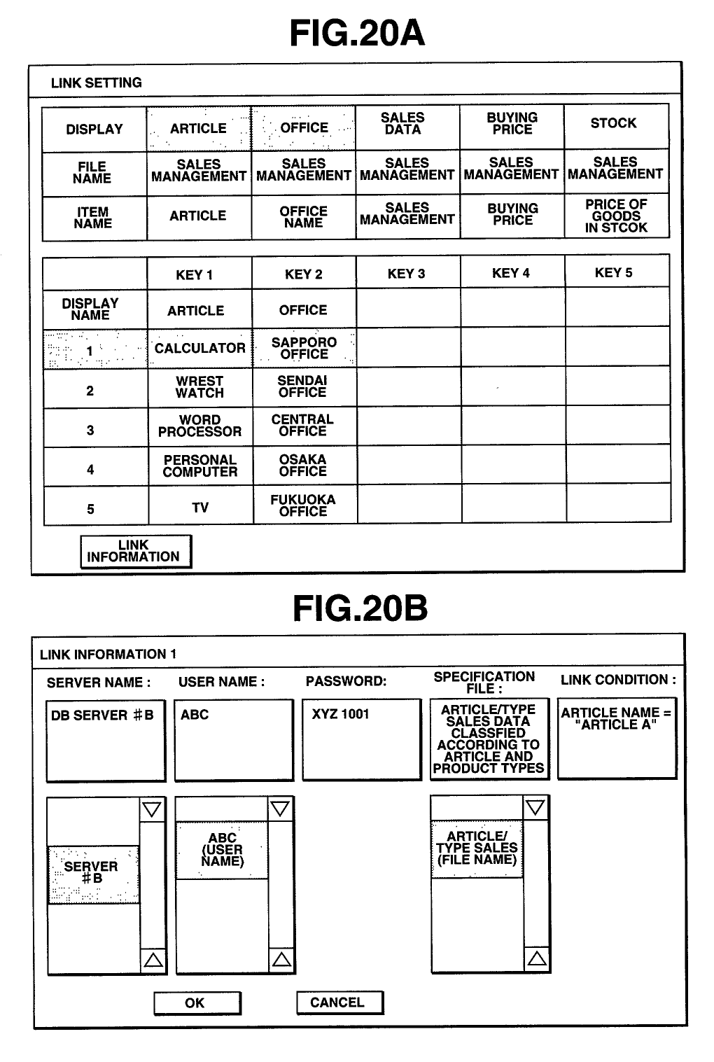

FIG. 19 is a flowchart for explaining a process of preparing a data link information file which is described in Step 1602 of FIG. 16. The operations of the flowchart can be realized as a process in which the WWW browser 401 included in the WWW client 302 executes a JAVA applet program which is downloaded from the WWW server 303. FIGS. 20A and 20B are diagrams exemplifying screens of the WWW browser 401 which is operated in a process for preparing the data link information file. The following steps 1901 to 1907 are the steps shown in the operational flowchart in FIG. 19.

When the list of the specification files 306 registered in the database server 304 located on the site 301, the user accesses the WWW browser 401, is displayed, the user specifies a desired specification file therefrom, by performing a mouse click.

Then, the user specifies to select a desired link key (i.e., the determination made in Step 1902 is “YES”). As a result of this, the user selects an arbitrary data item contained in the table corresponding to the currently-selected specification file 306, referring to the upper table which appears in the upper position on the browser screen shown in FIG. 20A (Step 1903). Then, the display name corresponding to the selected data item is displayed in sequential order from a “key 1” in the lower table which appears in the lower position on the browser screen shown in FIG. 20A.

The user sequentially sets a content value of each corresponding key at each key item included in the lower table on the browser screen shown in FIG. 20A (i.e., the determination made in Step 1904 is “YES”, and the flow advances to Step 1905).

The user selects, by performing a mouse click, one of the combinations of the content values set in the lower table on the browser screen shown in FIG. 20A, and clicks a “link information” button using a mouse, so that the browser screen alters in its style as shown in FIG. 20B. On the newly displayed screen, the user sets the contents of the to-be-linked information corresponding to the combinations of the selected content values, as the link information (refer to FIGS. 13 to 15) (i.e., the determination made in Step 1906 is “YES”, then the flow advances to Step 1907). The user selects, by referring to the displayed tables, a to-be-linked server name, a user name and a to-be-linked specification file name, and specifies and inputs a required password and a link condition by typing by means of a keyboard.

Sequentially, the user clicks, with a mouse, an “OK” button, which appears on the browser screen shown in FIG. 20B, and completes setting the data link information file 307 (i.e., the determination made in Steps 1902, 1904, 1906 is “NO”).

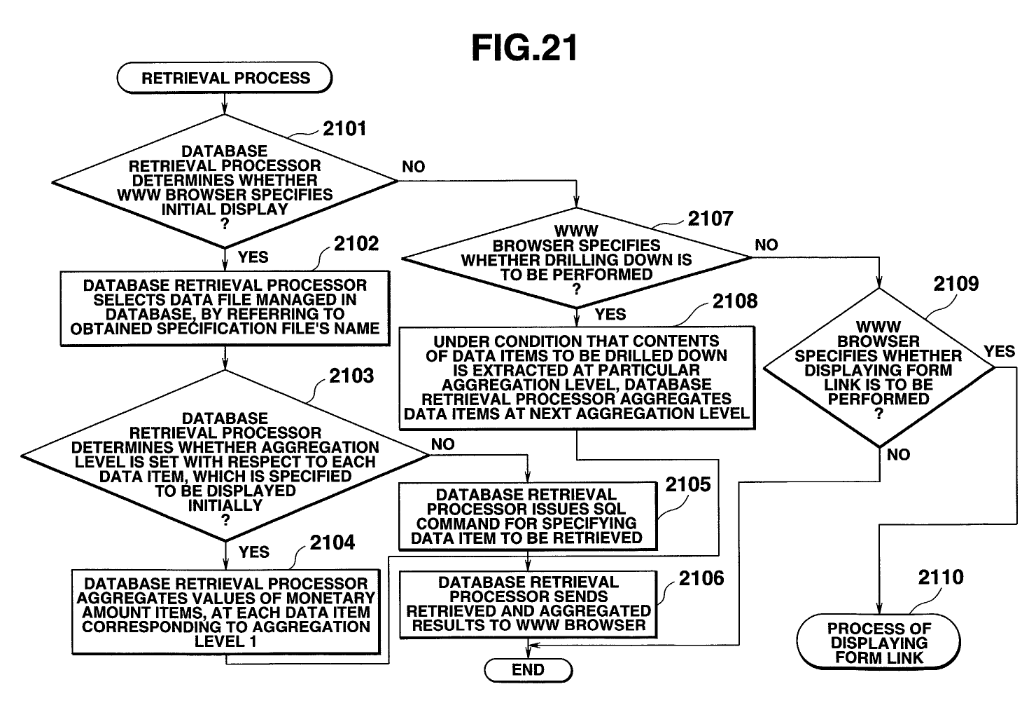

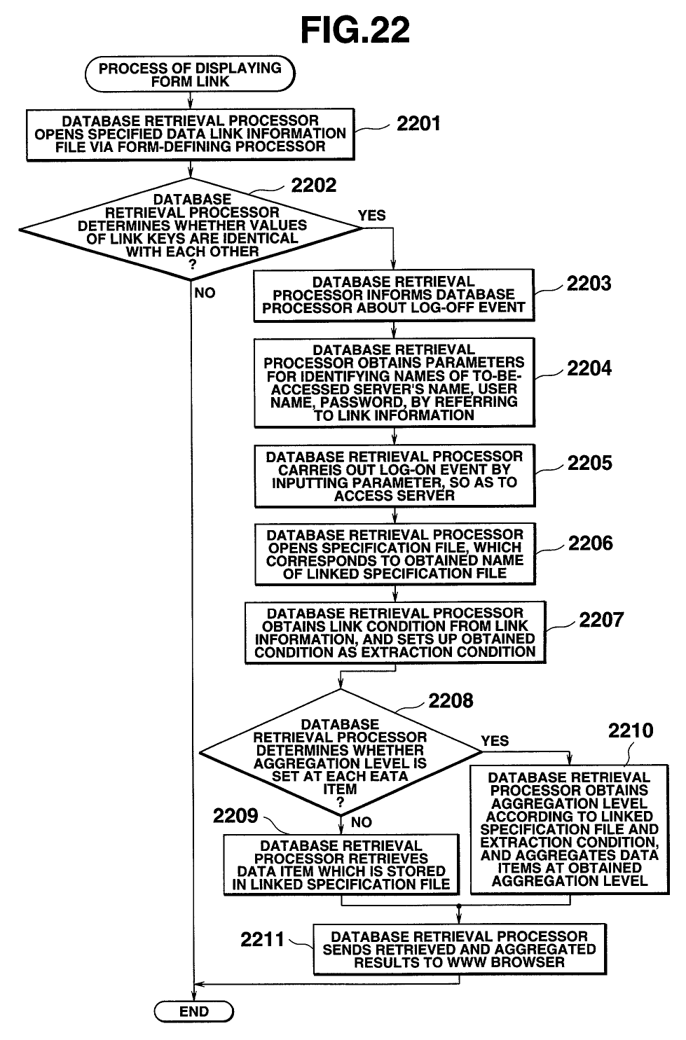

Each of FIGS. 21 and 22 is an operational flowchart for explaining a retrieval process which is executed by the database retrieval processor 403 (shown in FIG. 4) of the WWW server 303, in a manner corresponding to the retrieval process (shown in FIG. 16) performed by the WWW browser 401 in the WWW client 302, and for explaining a process for displaying a form link during the retrieval process.

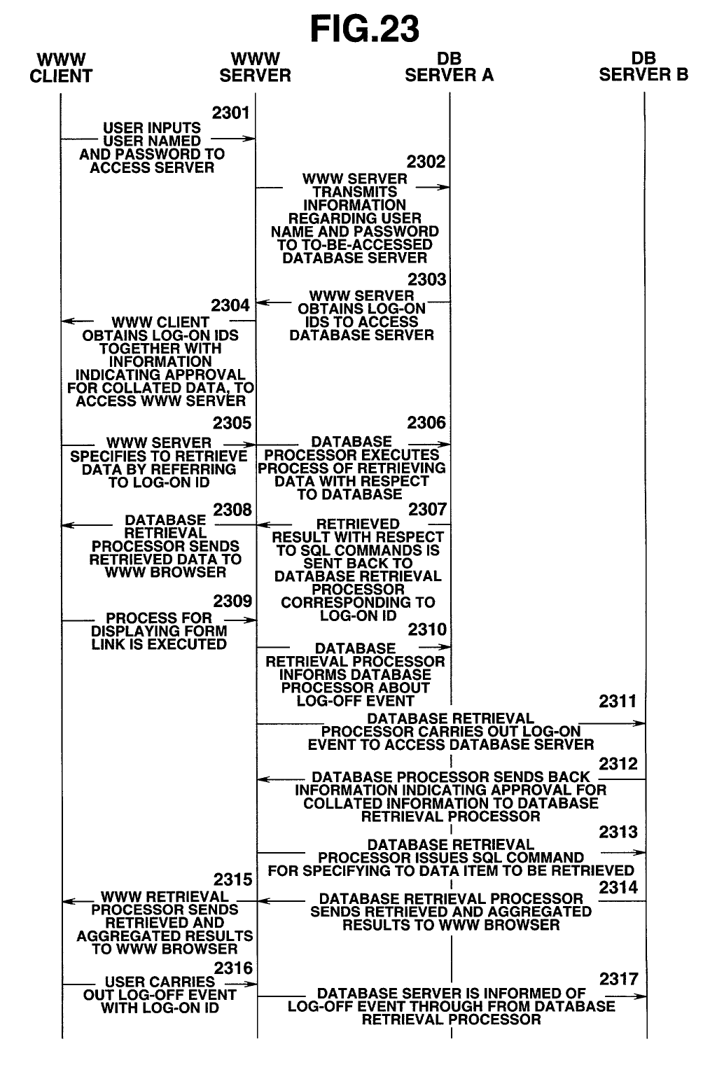

First, a process for logging on the WWW server 303 and the database server 304 from the WWW client 302 is executed. The process therefor is described in the diagram showing an operational sequence, in FIG. 23.

When the user specifies an URL (Uniform Resource Locator) of the associated WWW server 303, on the WWW browser 401 included in the WWW client 302, the WWW server unit 402 in the specified WWW server 303 allows the WWW browser 401 to display an input form in which the user can input a user name and a password. If the user inputs the user name and the associated password therein, the input information is transmitted to the WWW server unit 402 included in the WWW server 303 (Sequence 2301 shown in FIG. 23).

The WWW server unit 402 included in the WWW server 303 transmits the received information regarding the user name and the password to the database server 304 (DB server A) which can be accessed by a default (Sequence 2302 shown in FIG. 23).

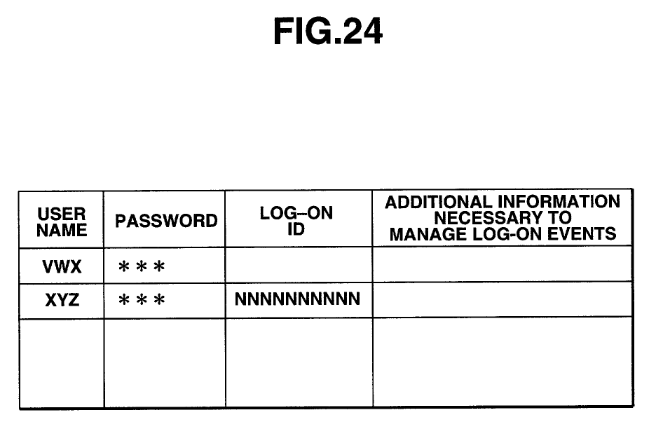

The database processor 404 included in the database server 304 manages, as shown in FIG. 24, the log-on management information file 406 containing the user names, passwords, log-on IDs, additional information necessary to manage log-on events (such as names, addresses and telephone numbers for contact), etc. The database processor 404 collates the user names and their required passwords sent from the WWW server unit 402 included in the WWW server 303, with the information contained in the log-on management information file 406. As the result of the collation, if those pieces of information correspond to each other, then the database processor 404 in the database server 304 (#A) sends back, to the WWW server unit 402 in the WWW server 303, the log-on ID contained in the collated log-on management information file 406 together with the information indicating the approval for the collated information.

The WWW server unit 402 activates a process to be operated by the database retrieval processor 403, in a manner corresponding to the sent log-on ID, and sends back the above-described log-on IDs together with the information indicating the approval for the collated data, to the WWW browser 401 of the WWW client 302 (Sequence 2304 shown in FIG. 23).

The WWW browser 401 of the WWW client 302 accesses the database server 304 (DB server A) with the log-on IDs sent from the WWW server 303. Specifically, when the WWW browser 401 specifies to retrieve a particular data item, with the received log-on ID (Sequence 2305), the WWW server unit 402 transmits the specification of data retrieval to the database retrieval processor 403 corresponding to the above-described log-on ID. Further, the database processor 403 generates SQL (Structured Query Language) commands, and sends the generated SQL commands to the database processor 404 included in the database server 304 (DB server A), then the database processor 404 therein executes a process for retrieving a particular data item stored in the database 305 (Sequence 2306). The retrieved result with respect to the SQL commands is sent back to the database retrieval processor 403 corresponding to the above-described log-on ID from the database processor 404 (Sequence 2307). Afterwards, the transmitted retrieved result is further sent back to the WWW browser 401 from the database retrieval processor 403 (Sequence 2308). The operational flowchart in FIG. 21 specifically shows the sequence of retrieval operational processes performed by the database retrieval processor 403 included in the WWW server 303.

The following steps 2101 to 2110 are the steps which are included in the operational flowchart shown in FIG. 21.

The database retrieval processor 403 determines that the WWW browser 401 specifies an initial display (Step 2101).

In the case where it is determined that the WWW browser 401 specifies the initial display, the database retrieval processor 403 obtains a specification file 306 which is specified from the WWW browser 401 via the form-defining processor 405 included in the database server 304 (DB server A) which can be accessed by a default. Further, the database retrieval processor 403 selects a table data file contained in the database 305 in the database server 304 (DB server A), by referring to the names of the obtained specification files (refer to FIG. 10 and the like) (Step 2102).

The database retrieval processor 403 determines that an aggregation level is set with respect to each data item specified to be displayed initially, by referring to the specification file 306 (Step 2103, refer to FIG. 10 and the like).

If the aggregation level (=aggregation level 1) is set with respect to each data item specified to be displayed initially, the database retrieval processor 403 sequentially issues an SQL command to the database processor 404 included in the database server 304 (DB server A). Now, the database retrieval processor 403 aggregates values of the “monetary amount” items at each data item of the item value corresponding to the aggregation level 1 (Step 2104).

The database retrieval processor 403 sends the retrieved and aggregated results to the WWW browser 401 of the WWW client 302 (Step 2106). As a result of this, the WWW browser 401 displays article sales data which is classified according to data items, as shown in FIG. 2A.

On the contrary, in a case where any aggregation level (=aggregation level 1) is not set with respect to each data item specified to be displayed initially, the database retrieval processor 403 issues an SQL command for specifying a data item to be simply retrieved, to the database processor 404 included in the database server 304 (DB server A) (Step 2105). Then, the database retrieval processor 403 sends the retrieved and aggregated results received from the database processor 404 to the WWW browser 401 of the WWW client 302 (Step 2106).

The user drills down one data item A included in the article sales data, which is displayed on the WWW browser 401 by performing a mouse click, as shown in FIG. 2A. In such a case, in the database retrieval processor 403, it becomes clear that the determination made in Step 2101 is “NO” and that made in Step 2107 is “YES”.

The database retrieval processor 403 sequentially issues an SQL command to the database processor 404 in the database server 304 (DB server A). Under the condition that the contents of the data item to be drilled down is extracted at a particular aggregation level, the database retrieval processor 403 aggregates values of the “monetary amount” items, at each item corresponding to the item value of the following aggregation level, which follows the above-described aggregation level (Step 2108).

The database retrieval processor 403 sends the retrieved and aggregated results to the WWW browser 401 of the WWW client 302 (Step 2106). The WWW browser 401 displays sales data, classified according to articles, specifically the article A, and offices, as shown in FIG. 2B.

Now, the user selects, by performing a mouse click, an office A included in the article sales data, which is displayed on the WWW browser 401 as shown in FIG. 2B, so that the database retrieval processor 403 corresponding to the log-in ID refers to a data link information file. In a case where a file specified to be drilled down is set, the determination made in Steps 2101 and 2107 is “NO”, whereas the determination made in Step 2109 is “YES”, thus a process for displaying a form link is executed in Step 2110 (refers also to Sequence 2309 shown in FIG. 23).

In a case where the WWW browser 401 specifies neither performing the initial display, drilling down a particular data item, nor displaying a form link (i.e., the determinations made in Steps 2101, 2107, 2109 are all “NO”), the database retrieval processor 403 carries out no process at all.

FIG. 22 is an operational flowchart for explaining a process for displaying a form link. The following steps 2201 to 2211 are the steps included in the operational flowchart in FIG. 22.

The database retrieval processor 403 opens a specified data link information file 307 via the form-defining processor 405 included in the database server 304 (DB server A) which can be accessible by a default (Step 2201).

The database retrieval processor 403 determines that values of link keys which the user has specified are identical with each other (Step 2202). For example, the user selects an office A included in the displayed article (particularly, article A)/office sales data. In such a case, it is determined that a combination of link key values of the office A and the article A is identical with a combination of values of the link keys 1 and 2, which are contained in the contents of the link information in the data link information file 307 shown in FIG. 13.

Unless such combinations of link key values are identical with each other, the process for displaying the form link will end as is (i.e., the determination made in Step 2202 is “NO”)

On the contrary, if such combinations of link key values are identical with each other, the database retrieval processor 403 informs, of a log-off event, the database processor 404 included in the database server 304 (DB server A) which can be accessed by a default (Step 2203, Sequence 2310 in FIG. 23).

The database retrieval processor 403 obtains parameters (refer to FIG. 13 and the like) for identifying names of to-be-linked servers, names of users and required passwords, by referring to the link information specifying the identical link key values included in the data link information file 307 (Step 2204).

Then, the database retrieval processor 403 carries out a log-on event by inputting the obtained user name and its corresponding password, so as to access the database server 304 (DB server B) corresponding to the obtained name of the to-be-linked server (Step 2205 and Sequence 2311 in FIG. 23).

The database processor 404, included in the database server 304 (DB server B) corresponding to of to-be-linked server's name, collates the to-be-linked user's name and its required password together with the information stored in the log-on management information file 406 in its server. As long as the result of the collation is “OK”, the database processor 404 sends back the information indicating the approval for the collated information to the database retrieval processor 403 included in the WWW server 303, the one requesting the link (Sequence 2312 in FIG. 23).

The database retrieval processor 403 obtains information regarding a name of a to-be-linked specification file (refer to FIG. 13, etc.) from the link information including the combinations of identical link key values which the data link information file 307 stores. The database retrieval processor 403 opens a specification file 306, which corresponds to the obtained name of the to-be-linked specification file, via the form-defining processor 405 included in the database server 304 (DB server B) located on the above-described “another” site (Step 2206).

Sequentially, the database retrieval processor 403 obtains the link condition (refer to FIG. 13, etc.) from the link information, regarding the combinations of identical link key values included in the data link information file 307, so as to set up the obtained link condition to the SQL command at the time of retrieval.

The database retrieval processor 403 determines whether or not the aggregation level is set at each item which is specified to display the form link, by referring to the specification file 306 obtained from the database server 304 (DB server B) located on the above-described “another” site (Step 2208).

In a case where the aggregation level is not set at each item which is specified to display the form link, the database retrieval processor 403 issues an SQL command for specifying to retrieve a data item and the extraction condition which is set in the database processor 404 (in Step 2207) included in the database server 304 (DB server B) located on the above-described another site (Step 2209). Then, the database retrieval processor 403 sends the retrieved and aggregated results obtained from the database processor 404 to the WWW browser 401 of the WWW client 302 (Step 221 and Sequences 2313 to 2315 in FIG. 23).

On the contrary, if the aggregation level is set at each item specified to display the form link, the database retrieval processor 403 sequentially issues an SQL command to the database processor 404 included in the database server 304 (DB server B) which is located on the above-described “another” site. The database retrieval processor 403 aggregates the values of the monetary amount items, at each item the above-described aggregation level (Step 2210, Sequences 2313 and 2314 shown in FIG. 23). Further, the database retrieval processor 403 sends the retrieved and aggregated results to the WWW browser 401 of the WWW client 302 (Step 2211, Sequence 2315 in FIG. 23). As a result of the above, the WWW browser 401 displays the article/type sales data, as shown in FIG. 2C.

Finally, if the user carries out a log-off event through from the WWW browser 401 of the WWW client 302, the database server 304 (DB server B) located on the above-described “another” site is informed of the log-off event via the database retrieval processor 403 included in the WWW server 303 (Sequences 2316 and 2317 in FIG. 23).

As explained above, in this embodiment of the present invention, if the user designs the specification file 306 and the data link information file 307 via the form-defining processor 405 of the WWW server 303 and of the database server 304, both of which are located on the to-be-linked site 301, through from the WWW browser 401 of the WWW client 302, the plurality of databases 305 which are arranged distributively in the plurality of sites 301 can be seamlessly connected.

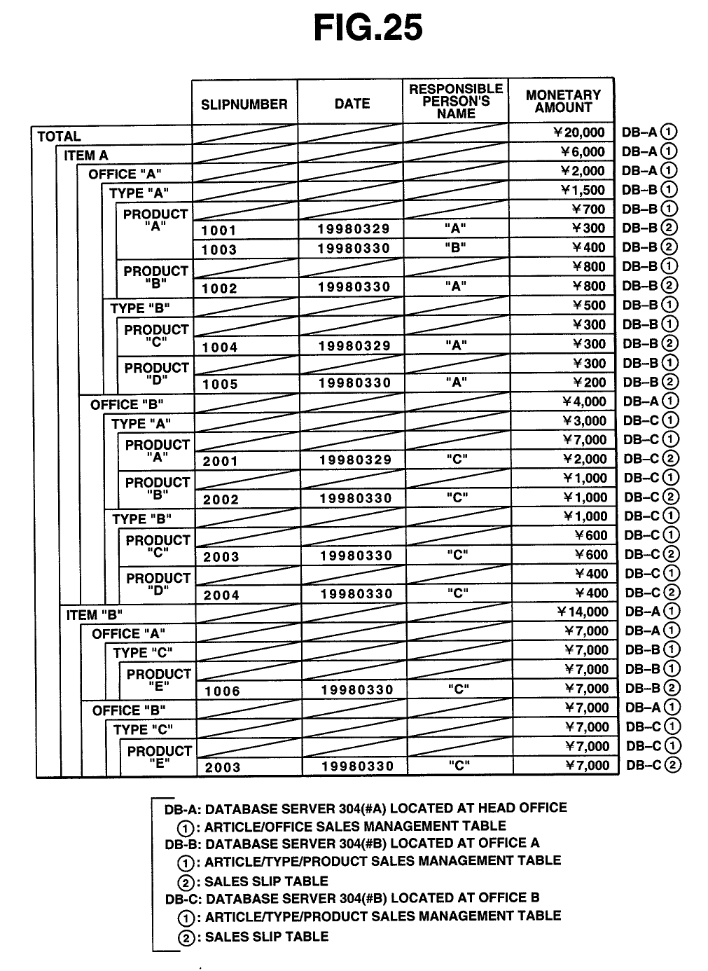

In the above-described embodiment, the case where the user performs data operations in the practice of drilling down is explained, however, the present invention is not limited to the above and can be realized when displaying a table of data obtained from the table in the distributively arranged databases 305, as shown in FIG. 25.

In such a case, the database retrieval processor 403 included in the WWW server 303 may analyze specification for retrieval, which is transmitted from the WWW browser 401, and may be operated so as to sequentially access (including to obtain the specification file 306, the data link information file 307 and the like) the database server 304 located on each corresponding site 301, thus the table shown in FIG. 25 can be displayed.

The present invention can be structured as a computer readable recording medium which allows a computer to operate various functions which are identical with those realized by the structures explained in the embodiment of the present invention, when used by a server computer. In this case, programs for realizing the functions of the above-described embodiment of the present invention is loaded in a memory (a RAM, a hard disk or the like) included in the server computer and is executed via a portable recording medium, such as a floppy disk, a CD-ROM disk, an optical disk, a removable hard disk and the like, or via a network.

Various embodiments and changes may be made thereonto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

What is claimed is:

1. A database access system which accesses tables contained in a plurality of databases distributively arranged on a network, said system comprising:
data link information defining means which defines, in a data link information file, a link from a table contained in one of the plurality of databases to another table in another database in the plurality of databases, with respect to each table contained in the plurality of databases which are distributively arranged on the network; and
database retrieval means which retrieves, when accessing a table contained in one of the plurality of databases, a link from the table to another table contained in another database in the plurality of databases, by referring to the data link information file, and which accesses the another table linked from the accessed table contained in the another database specified by the data link information file.

2. The system according to claim 1, further comprising a specification file defining means which defines, in a specification file, a method of displaying each data item included in each of the tables contained in the plurality of databases which are distributivey arranged on the network, and
wherein said database retrieval means controls, when accessing a table contained in the plurality of databases, a way of displaying each data item contained in the table, by referring to the specification file corresponding to the table.

3. The system according to claim 1, wherein:
said data link information file defining means, receives a request of defining link information from a World Wide Web (WWW) client, processes the request and sends back a processed result to the WWW client, based on a WWW interface; and
said database retrieval means receives and processes a request for accessing the table contained in the plurality of databases from the WWW client, on the basis of the WWW interface, and sends back a processed result to the WWW client.

4. The system according to claim 2, wherein:
said specification file defining means receives a request of defining link information from a World Wide Web (WWW) client, processes the request and sends back a processed result to the WWW client, based on a WWW interface; and
said database retrieval means receives and processes a request for accessing the table contained in the plurality of databases from the WWW client, on the basis of the WWW interface, and sends back a processed result to the WWW client.

5. The system according to claim 4, wherein each of said data link information file defining processor, the specification file defining processor and said database retrieval processor includes a part which can be executed on the WWW client.

6. A computer readable recording medium which records programs read out by a computer, said programs including:
a data link information definition function which defines, in a data link information file, a link from a table included in one of a plurality of databases to another table included in another database in the plurality of databases, with respect to each table contained in the plurality of databases which are distributively arranged on a network; and
a database retrieval process function which retrieves, when accessing a table contained in one of the plurality of databases, a link to a table included in another database in the plurality of databases, by referring to the data link information file, and which accesses the another table linked from the accessed table contained in the another database specified by the data link information file.

7. The computer readable recording medium according to claim 6, further comprising a specification file definition function which defines, in a specification file, a method of displaying each data item included in each table contained in a plurality of databases which are distributively arranged on the network, and
wherein said database retrieval definition function controls, when accessing a table included in the plurality of databases, a way of displaying each data item contained in the table, by referring to the specification file corresponding to the table.
